(19) United States
(12) Patent Application Publication
(10) Pub. No.: US 2020/0039148 A1
(43) Pub. Date: Feb. 6, 2020

(54) ADDITIVE MANUFACTURING PROCESS WITH CONVEYED GOODS CONVEYANCE BY MEANS OF POSITIVE PRESSURE

(71) Applicant: Siemens Aktiengesellschaft, 80333 München (DE)

(72) Inventors: JENS JÄHNICKE, Chemnitz (DE); MANFRED OCHSENKÜHN, Berg (DE); SONJA WOLFRUM, Erlangen (DE)

(73) Assignee: Siemens Aktiengesellschaft, 80333 München (DE)

(21) Appl. No.: 16/488,170

(22) PCT Filed: Feb. 2, 2018
(86) PCT No.: PCT/EP2018/052690

§ 371 Date: Aug. 22, 2019

(30) Foreign Application Priority Data
Feb. 23, 2017 (EP) 17157668.9

(51) Int. Cl. B29C 64/321; B33Y 30/00; B33Y 40/00; B33Y 50/00; B29C 64/386; B65G 53/12

(52) U.S. Cl. CPC B29C 64/321; B33Y 30/00; B33Y 40/00; B33Y 10/00; B29C 64/386; B65G 53/12; B33Y 50/00

(57) ABSTRACT

Conveyed goods of grains are fed from a pressure vessel into a conveyor line at a feed point for conveyance to a discharge point for supply to an extrusion head. The goods are plasticized in the extrusion head and extruded in a punctiform manner via a nozzle of the extrusion head. The extrusion head is moved dynamically by a manipulator during extrusion of the plasticized goods. Conveyor gas is force into the conveyor line by a gas compressor and allowed to escape the conveyor line at a separation point in a region of the discharge point. A gas positive pressure is temporarily applied by the gas compressor to the pressure vessel as the goods are fed from the pressure vessel into the conveyor line while bypassing the conveyor line via a first valve and closing a second valve in the conveyor line between the feed point and the gas compressor.

The present invention is based on an operational method for a production machine,
wherein conveyed goods consisting of grains with an average grain size are fed from a vessel into a conveyor line at a feed point, conveyed from there to a discharge point via the conveyor line, discharged out of the conveyor line at the discharge point and supplied to an extrusion head,
wherein the conveyed goods are plasticized in the extrusion head and after plasticization extruded in a punctiform manner via a nozzle of the extrusion head,
wherein the extrusion head is moved dynamically by means of a manipulator during the extrusion of the plasticized conveyed goods,
wherein a conveyor gas is compressed into the conveyor line in the region of the feed point by means of a gas compressor and is leaked out of the conveyor line at a separation point in the region of the discharge point.

The present invention is furthermore based on a production machine, wherein the production machine has a pressure vessel, a conveyor line with a feed point and a discharge point, an extrusion head with a nozzle, a manipulator and a gas compressor,
wherein conveyed goods consisting of grains with an average grain size are fed from the vessel into the conveyor line at the feed point, conveyed via the conveyor line to the discharge point, discharged out of the conveyor line there and supplied to the extrusion head,
wherein the conveyed goods are plasticized in the extrusion head and after plasticization extruded via the nozzle,
wherein the extrusion head is arranged on the manipulator and moved dynamically by means of the manipulator during the extrusion of the plasticized conveyed goods,
wherein a conveyor gas is compressed into the conveyor line in the region of the feed point by means of the gas compressor and leaked out of the conveyor line at a separation point in the region of the discharge point.

Such an operational method and the associated production machine are used, for example, in the context of additive manufacturing—colloquially often referred to as FDM=Fused Deposition Modeling or as FFF=Fused Filament Fabrication. In this method, a smeltable material—as a rule, a plastic—is supplied to an extrusion head as granules or powder, melted there and applied to a structure in a punctiform manner via a nozzle of the extrusion head. This creates a product layer by layer.

In the context of additive manufacturing, the material to be processed is supplied to the extrusion head during the manufacturing process. This results in the necessity to supply the conveyed goods continuously to the continuously changing position of the extrusion head—sometimes even against gravity. The conveyed goods are, generally speaking, a dry, disperse solid. Such substances can, in particular, be conveyed by means of mechanical conveying (for example, via feed screws). This type of conveyor has the advantages of good dosing and the possibility of continuous operation. A disadvantage, however, is that the grains of the conveyed goods are often very small, resulting in purely mechanical solutions being subject to the risk of jamming. As an alternative to mechanical conveying, the conveyed goods can also be conveyed pneumatically. In the case of pneumatic conveying, the grains of the conveyed goods are conveyed by means of an air or other gas flow through pipes over greater distances (sometimes several 100 m). In the case of pneumatic conveying, a distinction is in principle made between suction conveying and pressure conveying. In the case of suction conveying, the conveyor line is located on the negative pressure side of the gas compressor, in the case of pressure delivery on the positive pressure side of the gas compressor. In the case of pressure conveying, the reservoir, via which the conveyed goods are fed into the conveyor line, is also under pressure. It is therefore designed as a pressure vessel. In the pneumatic transport of conveyed goods (in the context of the present invention, these are powder and granules), suction conveying usually takes place. Suction conveying is usual, in particular in the supply of conveyed goods to plastic injection molding machines. In suction conveying, relatively large, bulky components are necessary, which must be arranged in the region of the discharge point. In the case of conventional plastic injection molding machines operated in a stationary manner, these components can be easily arranged. In additive manufacturing, on the other hand, the extrusion head is moved dynamically. If, in such a situation, the associated components for the suction conveying were to be arranged on the extrusion head, this would lead to reduced precision, to a reduced dynamic and to a restriction of the freedom of movement of the extrusion head.

A 3D-printing system and a 3D-printing method are known from EP 3117982 A1, in which a print head with a nozzle is moved relative to a building platform. Pellets are extruded in the print head which are fed to the print head by means of a flexible line using compressed air from a reservoir.

A method and a device for the pneumatic conveying of bulk material are known from the publication DE 19943504 A1, in which the bulk material is fed through a conveying line by means of a sluicing element in at least one place of consignment into an adjustable conveyor gas flow and is transported in the shape of discrete bulk material plugs spaced apart from one another by padding of conveyor gas from the place of consignment to at least one destination.

An automation system for an additive manufacturing process is known from WO 2016/088042 A1, which includes, inter alfa, a conveyor belt and a movable material print head. A filament to be printed is fed to the print head by means of a flexible line from a reservoir.

The object of the present invention is to provide possibilities by means of which a reliable supply of the extrusion head with conveyed goods can be ensured in a simple and efficient manner.

This object is achieved by an operational method for a production machine with the features of claim 1. Advantageous embodiments of the operational method are the subject of the dependent claims 2 to 9.

According to the invention, an operational method of the type mentioned at the outset is embodied such that,
a gas positive pressure is temporarily applied to the conveyed goods by means of the gas compressor in order to feed the conveyed goods into the conveyor line while bypassing the conveyor line via a first valve, and
during the pressurization of the pressure vessel with the gas positive pressure, a second valve which is arranged in the conveyor line between the feed point and the gas compressor is closed.

The basic idea of the present invention therefore consists of exerting a compressive force from the feed point on the conveyed goods conveyed in the conveyor line. In particular, there is therefore no suction of the conveyed goods originating from the discharge point, whereby a tensile force would be applied to the conveyed goods in the conveyor line. Implementation as a pressure supply makes it possible in particular to set a conveying state in the conveyor line in a targeted manner and thereby to adapt the conveying process to the conveyed material to be conveyed in a targeted manner.

The positive pressure is temporarily applied to the conveyed goods by means of the gas compressor in order to feed the conveyed goods into the conveyor line while bypassing the conveyor line via a first valve.

The feeding of the conveyed goods into the conveyor line is thereby rendered particularly efficient in that during the pressurization of the pressure vessel with the positive pressure, a second valve which is arranged in the conveyor line between the feed point and the gas compressor is closed.

The conveyor gas should be removed from the conveyed mass flow as completely as possible at the discharge point to enable the conveyed goods to be supplied to the extrusion head in a state which is as free from gas as possible. A particularly efficient embodiment of the discharge point is provided in that the discharge point forms the last part of the conveyor line and is designed as a hose which is permeable to the conveyor gas.

In the conveying of conveyed goods, that is to say, granules, powders and similar substances, by a conveyor gas, various types of conveying are known. These are explained in turn below. In the context of the following embodiments, it is initially assumed that the conveyor line runs horizontally.
In the case of airborne delivery, the particles are essentially distributed over the entire cross-section of the pipe. Larger particles such as plastic granules, for example, collide against each other and against the wall of the conveyor line and impulses are applied as a result which cause both lateral and rotational movements. In the case of finer particles, such movements are already caused by the turbulence of the gas flow as such. As a result of the gravitational force, more particles are located at the bottom of the conveyor line during horizontal conveying. The more slowly the conveyor gas flows and/or the heavier the particles are, the more the particles collect at the bottom of the conveyor line.
If the coordination of the velocity of the conveyed gas and the mass of the particles on top of each other is no longer sufficient to effect airborne delivery, some particles settle at the bottom of the conveyor line and are transported there more or less rapidly as so-called strands. This state is referred to as strand delivery. The transport movement is caused in this state in part by impacting particles and in part by resistance forces of the faster gas flow in the narrowed cross section.
If there is sufficiently large friction of the particles on the wall of the conveyor line, the strand delivery is converted into a so-called strand delivery over static deposition. The velocity of the gas flow in this case corresponds approximately to the sinking velocity of the particles.
If the velocity of the gas flow continues to decline (or if the mass of the particles increases accordingly), the solid is only conveyed in a dune-like manner, i.e., particles are blown over the crests of the dunes from the rear, but accumulate again immediately behind the crests in the lee of the wind. This state is referred to as dune conveying.
If the velocity of the gas flow declines further (or if the mass of the particles increases accordingly), bales form from the dunes which occupy a large part of the cross-section of the conveyor line. They are conveyed only slowly through the conveyor line. This state is referred to as bale conveying.
Both dune conveying and bale conveying are unstable states which can already change greatly in the event of slight fluctuations in the gas flow and/or the mass flow. They may clog the conveyor line if the gas compressor has insufficient pressure reserves. Finally, the bales fill the entire cross-section of the conveyor line in sections and plugs are formed. In this case, the conveyed goods can only be conveyed if the compressive force on the plug overcomes the friction thereof on the wall of the conveyor line (so-called plug conveying). In the case of relatively fine or medium coarse conveyed goods with high friction with the wall, the formation of plugs can clog the system. In the case of plug conveying, the dune effect only occurs in the uppermost region of the conveyor line. In the remaining region, a portion of the solid on the back side of the plug (i.e. on the side facing the pressure side) trickles down again and is resumed on the front side of the subsequent plug. The length of the plug is undetermined. This state is therefore also unstable. By means of suitable additional measures also known in the prior art, however, stable states can also be achieved in plug conveying.

The conveyor types explained above for the case of horizontal conveying also occur in a similar manner in the case of vertical conveying. This is well known to those skilled in the art.

Pure airborne delivery is also often referred to as dilute flow conveying, for the other types of conveying the term dense phase conveying is also often used as a collective term. With an airborne delivery, as a rule only relatively low loads can be achieved, which is usually 15:1 maximum. Loading is defined as the ratio of transported mass of conveyed goods and conveyed mass to conveyor gas. Airborne delivery is most often realized in practice. The reasons for this are the low pressure differentials required and the simplicity of ensuring a reliable, stable operating state. In the context of the present invention, however, dense phase conveying, in particular, plug conveying, is preferably carried out in the conveyor line. Considerably larger loads can be realized in dense flow conveying, for example of 100:1 or above, sometimes even up to 400:1.

In the case of pneumatic conveying, different pressure ranges are also differentiated. The pressure range between 0.2 bar and 1 bar is usually referred to as medium-pressure conveying. The use of pressures below 0.2 bar is referred to as low-pressure conveying, the use of pressures above 1 bar (as a rule, up to 10 bar maximum) is referred to as high-pressure conveying. In low-pressure conveying, fans are used as gas compressors. The flow velocity of the conveyed gas can be up to 30 m/s. As a rule, loading is up to 5:1, In medium-pressure conveying, rotary blowers are usually used. The flow velocity of the conveyed gas is usually between 15 m/s and 40 m/s. As a rule, the load is between 5:1 and 20:1, In high-pressure conveying, screw compressors or piston compressors are required as gas compressors. The flow velocity of the conveyed gas may be relatively low, for example approx. 2 m/s to approx. 10 m/s. Loading can reach values above 100:1, in particular, up to 150:1 and in some cases even up to 4100:1. In the context of the present invention, high-pressure conveying is preferably realized. Positive pressure is therefore preferably above 1 bar.

The average grain size is preferably at least 0.5 mm. An average grain size of 2.0 mm—better 1.5 mm and even better 1.0 mm—should not be exceeded, however. The grains are preferably spherical in shape. In the case of deviations from the exact spherical shape, the statistical variance of the distance of individual surface points from the center of gravity of the respective grain should be at most 10%. Furthermore, the average grain size should preferably be as uniform as possible. In particular, the statistical variance (lσ-variance) of the average grain size should be 20% maximum,

In order to ensure stable operation, a conveying state in the conveyor line is preferably detected by means of at least one sensor. In this case, the conveying state in a control device is compared with a target conveying state. The feeding of the conveyed goods into the conveyor line and/or the conveying of the conveyed goods in the conveyor line can be regulated by the control device as a function of the comparison.

For example, pressure sensors at certain points on the conveyor line can be used to record the respective local pressure in order to record the conveying state. From the evaluation of the pressure or its chronological sequence or (in the case of several detection points) of the local sequence or the chronological-local sequence, the conveying state can then be concluded. Controlling the feeding of the conveyed goods into the conveyor line can be done, for example, by varying the rhythm with which feeding takes place. In the simplest case, the period during which feeding takes place can be varied. In order to influence the distribution of the conveyed goods in the conveyor line, it is possible, for example, to inject gas into the conveyor line at predetermined points in addition. For this purpose, corresponding valves can be provided by way of which the supply of conveyor gas to the predetermined locations can be adjusted. A gas line (in other words, a line in which only the conveyor gas but not the conveyed goods is conveyed) is preferably laid in parallel with the conveyor line for this purpose.

The object is further achieved by a production machine with the features of the claim 10. Advantageous embodiments of the production machine are the subject of the dependent claims 11 to 15.

According to the invention, a production machine of the type mentioned at the outset is characterized in that,
the gas compressor is connected to the pressure vessel while bypassing the conveyor line via a first valve and the gas compressor temporarily applies a gas positive pressure to the pressure vessel in order to feed the conveyed goods into the conveyor line by opening the first valve, and
the gas compressor is connected to the conveyor line via a second valve and the second valve is dosed during the application of the gas positive pressure to the pressure vessel.

The advantageous embodiments of the production machine essentially correspond to those of the operational method.

The properties, features and advantages of this invention described above and the manner in which these are achieved will become dearer and more readily comprehensible in connection with the following description of the exemplary embodiments which are explained in more detail in connection with the drawings. In a schematic representation, the drawings show in:

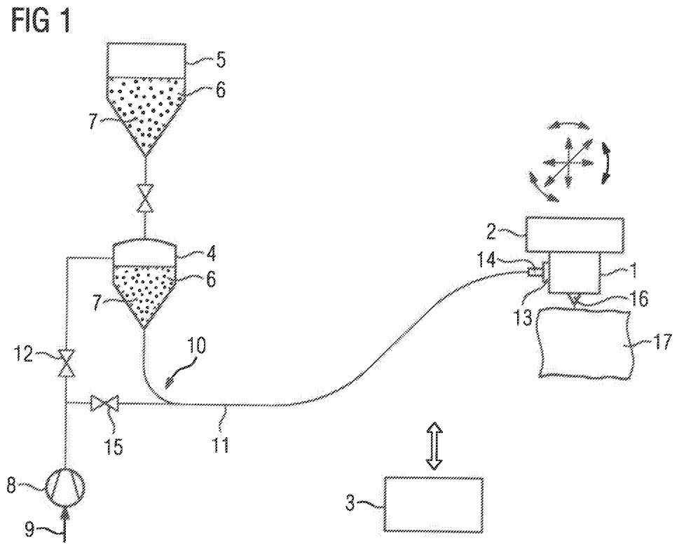

FIG. 1 a production machine,

FIG. 2 a time diagram,

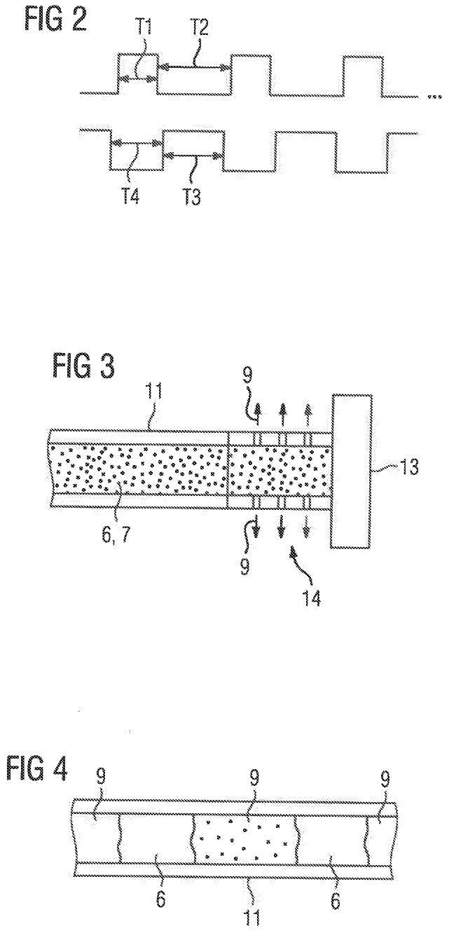

FIG. 3 an end section of a conveyor one,

FIG. 4 a section of a conveyor line,

FIG. 5 a grain of conveyed goods,

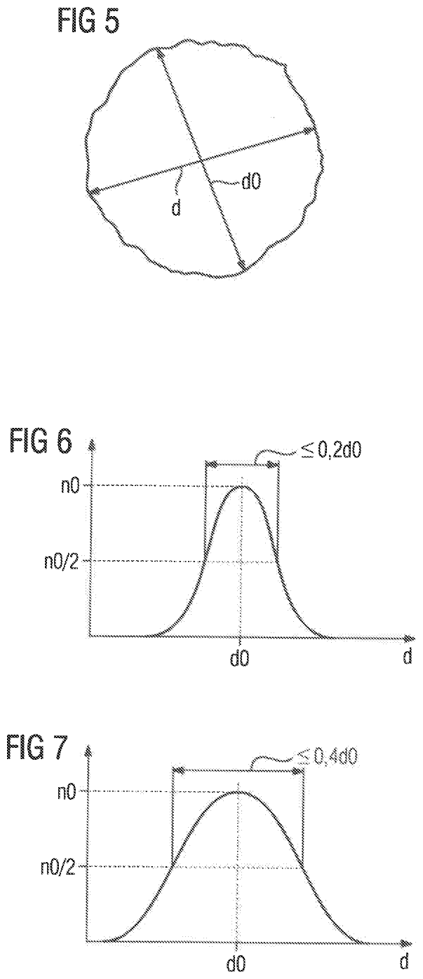

FIG. 6 a statistical evaluation of a grain size,

FIG. 7 a statistical evaluation of an average grain size and

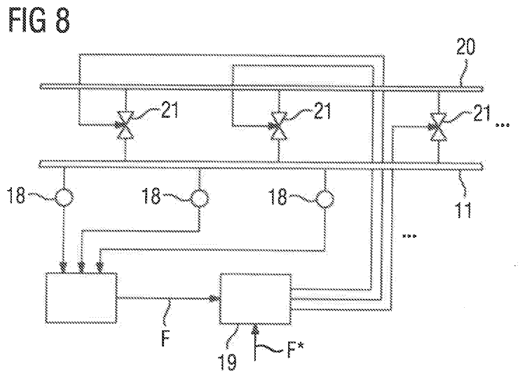

FIG. 8 a control structure.

According to FIG. 1, a production machine for additive manufacture—for example the so-called FDM method—has an extrusion head 1. The extrusion head 1 is arranged on a manipulator 2 of the production machine. The manipulator 2 can be moved—controlled by an automation device 3—in automated fashion. With the movement of the manipulator 2, the extrusion head 1 is also moved at the same time. The manipulator 2 is moved in at least three translational directions. This is indicated in FIG. 1 by three straight double arrows. Often a swiveling of the manipulator 2 (and with it, of the extrusion head 1) by up to three rotational orientations is also possible. This is indicated in FIG. 1 by three curved double arrows.

In the framework of the operation of the production machine, initially a pressure vessel 4, for example an autoclave, is filled from a reservoir 5, for example a silo, with a conveyed material 6. As a rule, the pressure vessel 4 is arranged in a fixed position. As a rule, the conveyed goods 6 are a plastic material. Alternatively, in individual cases it can be a metal. The conveyed goods 6 consist of a plurality of grains 7. After filling the pressure vessel 4, the pressure vessel 4 and the reservoir 5 are shut off. Furthermore, a positive pressure p is applied to the pressure vessel 4. The pressurization of the pressure vessel 4 with the positive pressure p takes place via a gas compressor 8 of the production machine which applies positive pressure p to a conveyor gas 9. As a rule, positive pressure p is above 1 bar, for example, between 1.5 bar and 10 bar. As a rule, the conveyor gas 9 is air. However, it may alternatively be another gas, for example a protective gas. The gas compressor 8 should have as steep a characteristic curve as possible (high increase in the pressure loss as a function of the velocity of the conveyed gas 9 emerging from the gas compressor 8). For example, the gas compressor 8 can be designed as a rotary blower or as a de Laval nozzle fed from a conventional compressed air network,

The conveyed goods 6 are fed from the pressure vessel 4 into a conveyor line 11 of the production machine at a feed point 10. The feed point 10 is located in the vicinity of the pressure vessel 4. The feeding of the conveyed goods 6 into the conveyor line 11 takes place in that the positive pressure p is temporarily applied to the conveyed goods 6—see FIG. 2 in addition—by the gas compressor 8 via a first valve 12 while bypassing the conveyor line 11 during first periods T1. During second periods T2 complementary thereto, in this case the positive pressure p is not applied to the pressure vessel 4. The gas compressor 8 is connected to the pressure vessel 4 in order to apply the positive pressure p to the pressure vessel 4 via the first valve 12, while bypassing the conveyor line 11. To apply the positive pressure p, the first valve 12 is temporarily opened, for the remainder of the time it is kept closed. The control of the first valve 12 is likewise carried out by the automation device 3.

From the feed point 9, the conveyed goods 6 are fed via the conveyor line 10 to a discharge point 13. For this purpose, the conveyor gas 9 can be compressed into the conveyor line 11 by means of the gas compressor 8 in the region of the feed point 10. At the discharge point 13, the conveyed goods 6 are discharged out of the conveyor line 11 and supplied to the extrusion head 1. Before feeding and supplying, however, the conveyor gas 9 leaks out of the conveyor line 11 at a separation point 14. As a result, the conveyed goods 6 are fed to the extrusion head 1 virtually free of conveyor gas 9. The leaking takes place automatically because of the positive pressure p. Active suction of the conveyed gas 9 is not necessary,

The separation point 14 can, for example, in accordance with the representation in FIG. 3, form the last part of the conveyor line 11 and be designed as a hose which is permeable to the conveyor gas 9. Alternatively, the separation point 14 can, for example, be designed as a membrane with a suitable permeability. Regardless of its structural design, however, the separation point 14 is designed in such a way that on the one hand it only permits the passage of the conveyor gas 9 but not also the grains 7 of the conveyed goods 6, while on the other hand, only offering the lowest possible flow resistance to the conveyor gas 9.

Depending on the embodiment of the production machine and arrangement of its individual components, the conveyor line 11 can be relatively short in individual cases (length of only a few meters). It is also possible, however, for the conveyor line 11 to be of a considerable length, for example several 100 m or even more than 1000 m.

In accordance with the representation in FIG. 1, a second valve 15 is arranged between the gas compressor 8 and the conveyor line 11. As a result, the gas compressor 8 is connected to the conveyor line 11 via the second valve 15. The second valve 15 is controlled by the automation device 3. The control can take place in particular in accordance with the representation shown in FIG. 2 in such a way that the second valve 15 is opened during third time periods T3 and is closed during complementary fourth periods T4. In accordance with the representation in FIG. 2, in this case the actuation of the first and second valve 12, 15 takes place essentially in a push-pull manner. In particular, during the application of the positive pressure p to the pressure vessel 4, the second valve 15 is thus closed. Actuation in push-pull need not correspond directly 1:1 with each other. It may be sufficient for some overlap to exist.

The conveyed goods 6 are plasticized in the extrusion head 1. For example, they can be melted by means of a heating device (not shown). The extrusion head 1 also has a nozzle 16. After plasticization, the conveyed goods 6 (which now no longer comprise grains 7 but are a plasticized mass) are extruded via the nozzle 16 in a punctiform manner. The plasticized mass is applied to a substrate 17 (which may in principle be of any nature). During the extrusion of the plasticized conveyed goods 6 (or the plasticized mass), the extrusion head 1 is moved dynamically by means of the manipulator 2. As a result, the desired structure is built up gradually. Due to the dynamic method of the extrusion head 1, even during the conveying of the conveyed goods 6, the conveyor line 11 is designed as a flexible hose at least in certain sections. Alternatively, or in addition, an embodiment may be possible with pipe sections which are connected to one another by means of joints.

In accordance with the representation in FIG. 4, dense phase conveying, in particular, plug conveying, is preferably carried out in the conveyor line 11. Loading can be 100:1 or above. If a different type of operation is desired in individual cases, however, this can easily be set—including in an automated manner,

In accordance with the representation in FIG. 5, the grains 7 of the conveyed goods 6 are preferably in the shape of a sphere. They have—see also FIG. 6—an average grain size d0 of at least 0.5 mm. Within the respective grain 7, however, slight fluctuations of the grain size d are possible as a function of the orientation under which the grain size d is determined. As a rule, fluctuation is at most within the limits of ±10%. Furthermore, from grain 7 to grain 7, the grains 7 display the most uniform possible average grain size d0. In particular, seen across a sufficiently large plurality of grains 7, the statistical variance of the average grain size d0 should be 20% maximum in accordance with the representation in FIG. 7, These embodiments facilitate the setting of a stable conveying state.

In accordance with the representation in FIG. 8, a conveying state F of the conveyor line 11 is preferably detected by means of the at least one sensor 18 (for example, a pressure sensor).

The conveying state F is supplied to a control device 19. The control device 19 can, for example, be realized as a software block within the automation device 3. In the control device 19, the conveying state F is compared to a target conveying state P. Depending on the comparison, the feeding of the conveyed goods 6 into the conveyor line 11 and/or the conveying of the conveyed goods 6 in the conveyor line 11 is regulated by the control device 19.

For example, the control device 19 can vary the periods at which feeding takes place—that is to say, the total of the periods T1 and T2. Variation can take place alternatively with or without variation of the ratio of the periods T1 and T2 in relation to one another. To the extent necessary and appropriate, the control device 19 can alternatively or in addition also vary the periods T3 and T4. Alternatively, or in addition, it is possible in addition to inject conveyor gas 9 into the conveyor line 11 at predetermined points. A gas line 20 is preferably laid parallel to the conveyor line 11 for this purpose. Only conveyor gas 9 is conveyed in the gas line 20, but not conveyed goods 6. The gas line 20 and the conveyor line 11 are connected to one another at predetermined points via valves 21. The additional conveyed gas 9 is injected by means of corresponding actuation of the valves 21 by the control device 19. Alternatively, or in addition, it is possible to vary the positive pressure p by means of appropriate actuation of the gas compressor 8.

If, in the context of the embodiments explained above the conveyed goods 6 are completely fed out of the pressure vessel 4 into the conveyor line 11 and conveyed to the extrusion head 1, the conveying of the conveyed goods 6 is briefly interrupted. After the positive pressure p has been reduced, the pressure vessel 4 is opened, refilled from the reservoir 5 and dosed again. Conveying of the conveyed goods 6 is then recommenced. Alternatively, it is possible to provide several pressure vessels 4 which can be connected in parallel or in series. By means of these embodiments it is possible to carry out conveying of the conveyed goods 6 almost continuously.

In summary, the present invention thus relates to the following facts:

Conveyed goods 6 consisting of grains 7 are fed from a pressure vessel 4 into a conveyor line 11 at a feed point 10, conveyed from there to a discharge point 13 via the conveyor line 11, discharged out of the conveyor line 11 and supplied to an extrusion head 1. The conveyed goods 6 are plasticized in the extrusion head 1 and then extruded in a punctiform manner via a nozzle 16 of the extrusion head 1. The extrusion head 1 is moved dynamically by means of a manipulator 2 during the extrusion of the plasticized conveyed goods 6. A conveyor gas 9 is compressed into the conveyor line 11 in the region of the feed point 10 by means of a gas compressor 8. It leaks out of the conveyor line 11 at a separation point 14 in the region of the discharge point 13.

The present invention has many advantages. By conveying the conveyed goods 6 through the conveyor line 11 by means of compression (as opposed to suction), simple conveying of the conveyed material 6 is made possible without adversely affecting the operation of the extrusion head 1 (in particular its dynamic positioning including the static and/or dynamic positioning accuracy). As a result of dense phase conveying, energy-efficient, low-wear operation of the conveyor line is obtained. This applies, in particular, in the case of plug conveying. Very high loads (as a rule, of at least 100:1, in extreme cases up to 400:1) can be conveyed over long conveyor lines (in some cases up to several km). In particular, in an application in a printer park with a plurality of production machines, longer conveyor lines 11 can be used as a result which are fed with conveyed goods 6, for example, from a common pressure vessel 4. Under certain circumstances, additional treatments of the conveyed goods 6 can take place within the conveying section, for example drying or preheating. It may even be possible to feed different conveyed goods 6 from a plurality of pressure vessels 4 sequentially into the conveyor line 11 in a controlled manner and thereby supply the extrusion head 1 with a premixed mixture of conveyed goods 6 which need only be melted in the extrusion head 1 but need no longer be further mixed.

1.-15. (canceled)

16. A method for operating a production machine, said method comprising:
feeding conveyed goods in the form of grains with an average grain size from a pressure vessel into a conveyor line at a feed point for subsequent discharge of the goods at a discharge point and supply to an extrusion head;
plasticizing the conveyed goods in the extrusion head;
extruding the conveyed goods in a punctiform manner via a nozzle of the extrusion head, while moving the extrusion head dynamically by a manipulator;
forcing a conveyor gas by a gas compressor in a region of the feed point into the conveyor line;
allowing the conveyor gas to leak out the conveyor line at a separation point in a region of the discharge point; and
temporarily applying by the gas compressor a gas positive pressure to the pressure vessel as the conveyed goods are fed from the pressure vessel into the conveyor line while bypassing the conveyor line via a first valve and closing a second valve in the conveyor line between the feed point and the gas compressor,

17. The method of claim 16, wherein the discharge point forms a last part of the conveyor line and is designed as a hose which is permeable to the conveyor gas.

18. The method of claim 16, wherein a dense phase conveying takes place in the conveyor line, in particular a plug conveying,

19. The method of claim 16, wherein a ratio between a conveyed mass of conveyed goods and a conveyed mass of conveyor gas is 100:1 or above.

20. The method of claim 16, wherein the gas positive pressure is above 1 bar.

21. The method of claim 16, wherein the average grain size is at least 0.5 mm.

22. The method of claim 16, wherein the grains are spherical,

23. The method of claim 16, wherein the average grain size has a statistical variance of 20% maximum.

24. The method of claim 16, further comprising:
detecting by a sensor a conveying state in the conveyor line;
comparing by a control device the conveying state with a target conveying state; and
controlling by the control device a feeding of the conveyed goods into the conveyor line and/or a conveying of the conveyed goods in the conveyor line.

25. A production machine, comprising:
a pressure vessel containing conveyed goods in the form of grains with an average grain size;
a manipulator;
an extrusion head configured for plasticizing the conveyed goods and including a nozzle for extruding plasticized conveyed goods, said extrusion head being arranged on the manipulator for dynamic movement during extrusion of the plasticized conveyed goods;
a conveyor line including a feed point for receiving conveyed goods from the pressure vessel for subsequent conveyance and discharge of the conveyed goods at a discharge point to the extrusion head;
a gas compressor connected to the conveyor line to force a conveyor gas into the conveyor line hi a region of the feed point, with the conveyor gas being allowed to leak out the conveyor line at a separation point in a region of the discharge point, said gas compressor being connected to the pressure vessel;
a first valve allowing conveyor gas to flow from the gas compressor to the pressure vessel while bypassing the conveyor line so as to temporarily apply a gas positive pressure to the pressure vessel, as the conveyed goods is fed into the conveyor line and the first valve is open; and
a second valve configured to control a flow of conveyor gas from the gas compressor to the conveyor line, said second valve being dosed, when the gas positive pressure is temporarily applied to the pressure vessel.

26. The production machine of claim 25, wherein the discharge point forms a last part of the conveyor line and is designed as a hose which is permeable to the conveyor gas.

27. The production machine of claim 25, wherein in the conveyor line a dense phase conveying, in particular plug conveying, is performed.

28. The production machine of claim 25, wherein a ratio between a conveyed mass of conveyed goods and a conveyed mass of conveyor gas is adjustable at 100:1 or above.

29. The production machine of claim 25, wherein the gas positive pressure is above 1 bar.

30. The production machine of claim 25, further comprising:
a sensor configured to detect a conveying state in the conveyor one; and
a control device configured to compare the conveying state with a target conveying state and to control a feeding of the conveyed goods into the conveyor line and/or conveyance of the conveyed goods in the conveyor line in response to the comparison between the conveying state with a target conveying state.
